(19) United States
(12) Patent Application Publication
(10) Pub. No.: US 2011/0296124 A1
(43) Pub. Date: Dec. 1, 2011

(54) PARTITIONING MEMORY FOR ACCESS BY MULTIPLE REQUESTERS

(76) Inventors: Sheri L. Fredenberg, Windsor, CO (US); Jackson L. Ellis, Fort Collins, CO (US); Eskild T. Arntzen, Cheyenne, WY (US)

(21) Appl. No.: 12/899,681

(22) Filed: Oct. 7, 2010

Related U.S. Application Data
(60) Provisional application No. 61/347,864, filed on May 25, 2010.

(51) Int. Cl. G06F 12/02; G06F 13/00; G06F 12/00

(52) U.S. Cl. 711/157; 711/173; 710/52; 711/E12.002

(57) ABSTRACT

An apparatus comprising a plurality of buffers and a channel router circuit. The buffers may be each configured to generate a control signal in response to a respective one of a plurality of channel requests received from a respective one of a plurality of clients. The channel router circuit may be configured to connect one or more of the buffers to one of a plurality of memory resources. The channel router circuit may be configured to return a data signal to a respective one of the buffers in an order requested by each of the buffers.

This application claims the benefit of U.S. Provisional Application No. 61/347,864, filed May 25, 2010 and is hereby incorporated by reference in its entirety.

The present application may relate to co-pending application Ser. No. 12/857,716, filed Aug. 17, 2010 and Ser. No. 12/878,194, filed Sep. 9, 2010, which are each hereby incorporated by reference in their entirety.

### FIELD OF THE INVENTION

The present invention relates to memory storage generally and, more particularly, to a method and/or apparatus for implementing a system to partition one or more memory resources to be accessed by multiple requesters.

### BACKGROUND OF THE INVENTION

Conventional memory subsystems are designed to allow one requestor at a time to have access to a memory resource. In such systems, a tight coupling between the requestor and the memory subsystem is implemented. Tight coupling makes modification of any part of the memory subsystem difficult without impacting the other parts of the system. Similarly, such coupling does not allow different types of memories such as DRAM and SRAM to share a common address space. Furthermore, in such conventional approaches all requestors are assumed to be synchronous to the memory subsystem. Such an approach contributes to routing congestion due to the large number of possible long routes needed to access the different memory subsystems.

It would be desirable to implement a method and/or apparatus for partitioning memory that is scalable to allow access to a large number of memory resources to provide, for example, improved system bandwidth by having any given requestor have parallel access to multiple memory subsystems.

### SUMMARY OF THE INVENTION

The present invention concerns a plurality of buffers and a channel router circuit. The buffers may be each configured to generate a control signal in response to a respective one of a plurality of channel requests received from a respective one of a plurality of clients. The channel router circuit may be configured to connect one or more of the buffers to one of a plurality of memory resources. The channel router circuit may be configured to return a data signal to a respective one of the buffers in an order requested by each of the buffers.

The objects, features and advantages of the present invention include implementing a system that may (i) be expandable to a large number of memory resources, (ii) allow for shared access by a plurality of requestors to any memory resource, (iii) reduce area and/or implementation cost, (iv) allow parallel access by different or the same requestor to different memory resources, (vi) allow all the different memory resources to become part of the same memory map, (vii) allow independent arbitration for each memory resource, (viii) allow different criteria to be used in the arbitration for each memory resource and/or (ix) allow the same requestor logic and interface to be used to access dissimilar memory resources.

### BRIEF DESCRIPTION OF THE DRAWINGS

These and other objects, features and advantages of the present invention will be apparent from the following detailed description and the appended claims and drawings in which:

FIG. 1 is a block diagram of a system in accordance with the present invention;

FIG. 2 is a more detailed diagram of the system of FIG. 1;

FIG. 3 is a computer system with hard disk drives;

FIG. 4 is a block diagram of a hard disk drive; and

FIG. 5 is a block diagram of a hard disk controller.

### DETAILED DESCRIPTION OF THE PREFERRED EMBODIMENTS

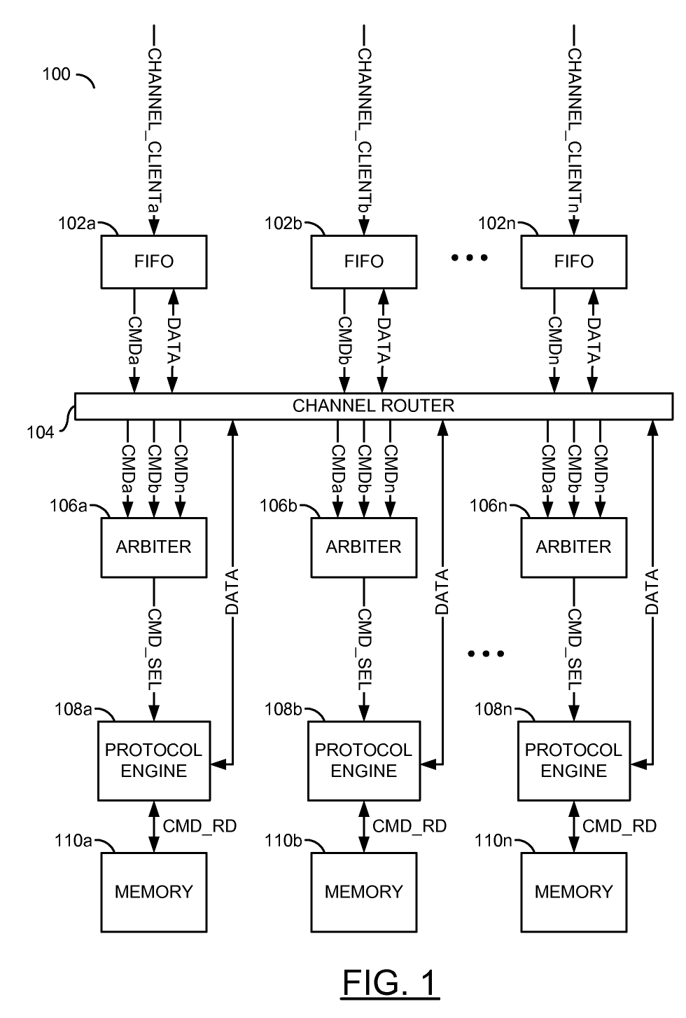

Referring to FIG. 1, a block diagram of a system 100 is shown in accordance with a preferred embodiment of the present invention. The system 100 generally comprises a plurality of blocks (or circuits) 102a-102n, a block (or circuit) 104, a plurality of blocks (or circuits) 106a-106n, a plurality of blocks (or circuits) 108a-108n and a plurality of blocks (or circuits) 110a-110n. The circuits 102a-102n may each be implemented as a buffer circuit. For example, the circuits 102a-102n may be implemented as First-In First-Out (FIFO) memory circuits. The circuit 104 may be implemented as a channel router circuit. The circuits 106a-106n may each be implemented as an arbiter circuit. The circuits 108a-108n may each be implemented as a protocol engine circuit. The circuits 110a-110n may each be implemented as a memory circuit.

In one example, the memory circuits 110a-110n may be implemented as external memory circuits (e.g., on a separate integrated circuit from the circuits 102a-102n and the channel router circuit 104). In another example, the memory circuits 110a-110n may be implemented as internal memory circuits (e.g., implemented on an integrated circuit along with the circuits 102a-102n and the channel router circuit 104). In one example, the memory circuits 110a-110n may each be implemented as a dynamic random access memory (DRAM). The particular type of DRAM implemented may be varied to meet the design criteria of a particular implementation. In another example, the memory circuits 110a-110n may each be a double data rate (DDR) memory circuit. The memory circuits 110a-110n may be implemented as a variety of types of memory circuits.

The circuits 102a-102n may each receive a respective one of a number of signals (e.g., CHANNEL_CLIENTa-n) from a number of clients (or requesters). The signals CHANNEL_CLIENTa-n may be request signals. The circuits 102a-102n may present a number of control signals (e.g., CMDa-CMDn) and a number of data signals (e.g., DATAa-DATAn) to the channel router circuit 104. In one example, the control signals CMDa-CMDn may be implemented as command signals. The circuit 104 may present each of the control signals CMDa-CMDn to each of the arbiter circuits 106a-106n. The arbiter circuits 106a-106n may each present a signal (e.g., CMD_SEL) to one of the protocol engines 108a-108n. The signal CMD_SEL may represent one of the control signals CMDa-CMDn selected by the arbiter circuits 106a-106n.

The system 100 may allow simultaneous access to the memory circuits 110a-110n by two or more of the request signals CHANNEL_CLIENTa-n. Each of the request signals CHANNEL_CLIENTa-n may provide requests for access to one of the memory circuits 110a-110n. In one example, the arbiter circuits 106a-106n may have registered inputs and outputs. This may allow greatly reduced routing congestion. The partitioning may allow for simplicity and/or focus within the arbiter circuits 106a-106n and/or the protocol engine circuit 104. Easy modifications and/or updates to a particular one of the subsystems may be implemented.

The circuit 100 may provide a modular and/or scalable implementation. The circuit 100 may support 1 to N different memory circuits 110a-110n. The memory circuits 100a-100n may be implemented as a mix of similar and/or different memory types (e.g., SRAM, DRAM, etc.). Implementing different memory types may allow the cost of implementing a system to be reduced. For example, high bandwidth and/or low latency memories may be implemented in parallel with high capacity memories. The circuit 100 may support memory circuits 100a-100n that are implemented both internally and/or externally to the circuit 100. The circuit 100 may support memory circuits 100a-100n that are interleaved by low address bits (e.g., dword, 64-byte, etc.) to increase effective bandwidth out of the memory subsystem. The particular number of memory circuits 110a-110n may be scaled to provide additional parallel paths. Such scaling may provide an increase in bandwidth. The circuit 100 may support 1 to N different requestors. The number of requestors may be the same number, or a different number, as the number of memory circuits 110a-110n. The circuit 100 may support more than one FIFO per client to effectively provide more bandwidth from the requestor. From the perspective of the channel router circuit 104, each of the FIFO circuits 102a-102n may be connected to a different requestor. While a particular requestor is waiting for access to the memory circuits 110a-110n, the requestor may process two bursts at a time and/or fill one or more of the FIFO circuits 102a-102n.

The circuit 100 may provide improved system bandwidth by having parallel access to one or more of the memory subsystems 110a-110n. Implementing a channel router 104 may result in reduced congestion by reducing the number of long routes to each of the memory resource 110a-110n. In one example, all of the memory resources 110a-110n may be configured to share a common address space. In another example, the circuit 100 may be expandable to a large number of memory resources.

The FIFO circuits 102a-102n may allow each of the different requesters to operate at a frequency that is different from the frequency of the memory circuits 110a-110n. Such an implementation may allow a loose coupling between the particular requestor and the memory circuits 110a-110n. The buffer circuits 102a-102n may provide arbitration latency absorption. The FIFO circuits 102a-102n may have a separate clock domain for the signals CMDa-n and the signal DATA. The signal CMD operates at a frequency of the corresponding arbiter circuits 106a-106n. The signal DATA may operate at a frequency of the protocol engine circuits 108a-108n. If the corresponding arbiter circuits 106a-106n and the corresponding protocol engine circuit 108a-108n have different frequencies, then the signal CMD_SEL may be an asynchronous signal configured to communicate the next command to perform.

The channel router 104 may allow shared access to one or more of the memory circuits 110a-110n. Area and/or cost may be minimized by reducing the number of signals for each memory. A client generally only has one copy that the channel router 104 broadcasts to all the arbiters 106a-106n. Each device may have a unique address. Part of the incoming address may be used as a selection term for the particular memory circuits 110a-110n being requested. For example, if only two of the memory circuits 110a-110n are being shared, then the most significant bit of the address may be used to select between the two memory circuits 110a-110n being shared. If there are more than two of the memory circuits 110a-110n being shared, then a variety of schemes may be used to select between the memory circuits 110a-110n by using a combination of address bits.

The channel router 104 may present the signals CMDa-CMDn to one of the arbiters 106a-106n. The channel router 104 may also enable a selected data path based on the result of the arbitration. Parallel access to each of the different memory circuits 110a-110n by different requestors may allow for additional bandwidth. The channel router 104 may also resolve out of order data problems returned to the requestor if a requestor has outstanding requests to more than one memory circuit 110a-110n. For example, the channel router 104 may hold off requests from a particular requestor for access to a different one of the memory circuits 110a-110n instead of the currently active memory circuit 110a-110n until the access to the active memory subsystem is complete. The channel router 104 may be implemented to provide an order of multiplexing that matches the physical layout of the integrated circuit. In one example, if the FIFO 102a and the FIFO 102b are near each other, then the channel router 104 may multiplex the outputs of the FIFO circuit 102a and the FIFO circuit 102b first and then multiplex this result with the remaining FIFO circuits 102a-102n. This may allow the channel router 104 to reduce the congestion for the multiple channel clients to access the multiple arbiters 106a-106n.

The arbiter circuits 106a-106n may perform independent arbitration for each of the memory circuits 110a-110n. The arbitration may be tuned to the particular type of memory implemented (e.g., banks of a DDR, minimizing read/write transitions, etc.). The arbiter circuits 106a-106n may determine which of the incoming requests to provide to the particular protocol engines 108a-108n next. The particular type of arbitration scheme implemented may be varied to meet the design criteria of the overall system.

The protocol engine circuits 108a-108n may queue the command signals CMDa-CMDn in the order received by the arbiter circuits 106a-106n. The arbiter circuits 106a-106n may decide which of the command signals CMDa-CMDn the protocol engine circuits 108a-108n receives next. Any one of the protocol engine circuits 108a-108n may process the selected command signals CMD_SEL from a corresponding arbiter circuit 106a-106n. For example, 108a may process commands received from the arbiter 106a. The protocol engines 108a-108n may process the commands provided by the arbiters 106a-106n. The protocol engines 108a-108n may control writes and/or reads of data to/from the memory circuits 110a-110n. The protocol engines 108a-108n may be configured to run the particular protocol used by each type of memory.

The memory circuits 110a-110n may each be implemented using any memory type of addressable memory currently available or potentially available in the future. The memory circuits 110a-110n may be implemented as volatile memory. For example, the memory circuits 110a-110n may be implemented as RDRAM, SDRAM, DRAM, etc. The memory circuits 110a-110n may be implemented as volatile or non-volatile memory. In one example, the memory circuits 110a-110n may be implemented as flash memory. The memory circuits 110a-110n may be implemented as internal memory, external memory, or a combination. A mixture of a variety of types of memory circuits 110a-110n may be implemented. The memory circuits 110a-110n may write data in response to write command signals CMD_SEL received from the protocol engine circuit 104. The memory circuits 110a-110n may provide read data in response to read command signals CMD_RD received from the protocol engine circuit 104.

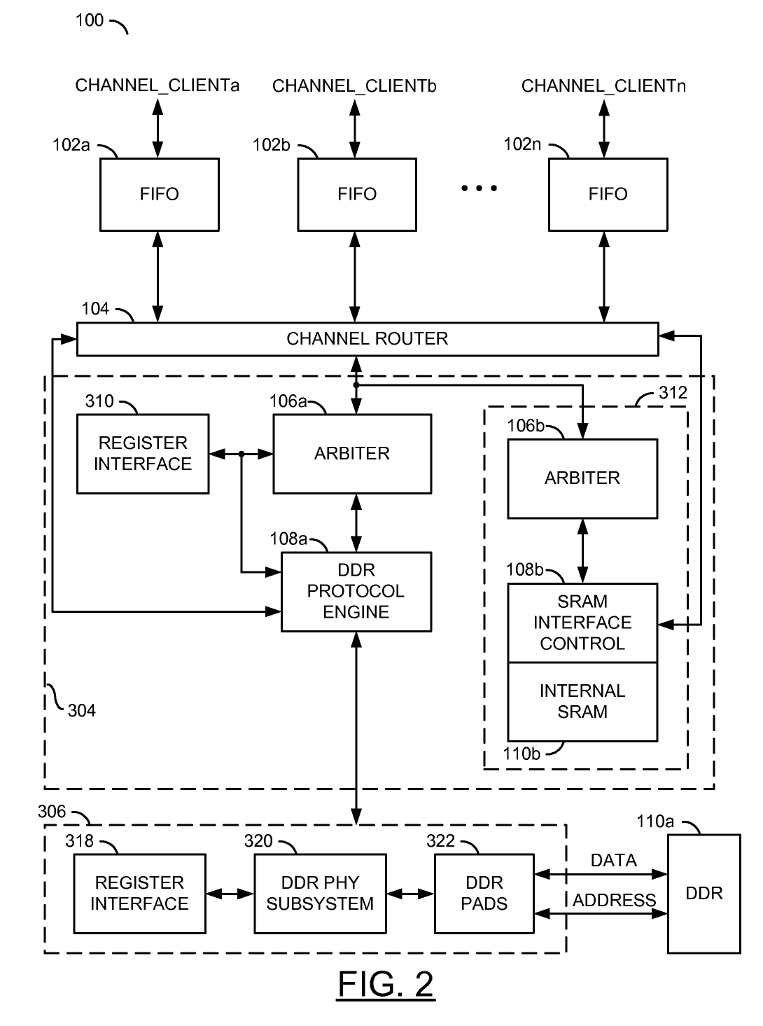

Referring to FIG. 2, a more detailed diagram of the circuit 100 is shown. In addition to the circuits 102a-102n, the channel router circuit 104 and the memory circuits 110a-110n, the circuit 100 comprises a block (or circuit) 304 and a block (or circuit) 306. The circuit 304 may be implemented as a memory controller circuit. The circuit 306 may be implemented as a DDR PHY interface circuit. The circuit 304 and the circuit 306 illustrate details of one of the data paths.

The circuit 304 generally comprises the arbiter circuit 106a, the protocol engine 106, a register interface circuit 310 and an internal memory controller circuit 312. The internal memory controller circuit 312 may comprise another arbiter circuit 106b, an SRAM interface control circuit 108b and an internal SRAM memory circuit 110b. The circuit 306 may comprise a register interface 318, a DDR PHY subsystem 320 and a DDR pad circuit 322.

The protocol engine 108 may implement DDR1, DDR2, and/or DDR3 protocol compliant with JEDEC standards. Other protocols, such as the DDR4 standard, which is currently being worked on by JEDEC committees, may also be implemented. The protocol engine 108 may use various programmable parameters to allow support for the full JEDEC range of devices in accordance with various known specifications. Firmware may be used to drive the DDR initialization sequence and then turn control over to the protocol engine 108. The protocol engine 108 may provide periodic refreshes that may be placed between quantum burst accesses. The protocol engine 108 control may support a prefetch low-power mode as an automatic hardware initiated mode and a self-refresh low-power mode as a firmware initiated mode. The protocol engine 108 may also bank interleave each access with the previous access by opening the bank while the prior data transfer is still occurring. Other optimizations may be provided by the protocol engine 108 to reduce the overhead as much as possible in the implementation of the DDR sequences.

The subsystem 306 may be implemented as one or more hardmacro memory PHYs, such as the DDR1/2 or DDR2/3 PHYs. The subsystem 306 may be interfaced to the memory circuits 110a-110n through the DDR pads 322. The DDR pads 322 may be standard memory I/F pads which may manage the inter-signal skew and timing. The DDR pads 322 may be implemented as modules that may either be used directly or provided as a reference to customer logic where the DDR pads 332 will be implemented. The DDR pads 322 may include aspects such as BIST pads, ODT, and/or controlled impedance solutions to make the DDR PHY 306 simple to integrate.

The register interfaces 310 and 318 may allow the memory controller module 304 and DDR PHY 306 to reside on a bus for accessing registers within the subsystem. In one example, an ARM APB3 bus may be implemented. However, the particular type of bus implemented may be varied to meet the design criteria of a particular implementation. These registers may or may not directly allow access to the external memory 110a and/or the internal SRAM 110b. The signals CHANNEL_CLIENTa-n may initiate writes and/or reads to the external memory 110a and/or the internal SRAM 110b.

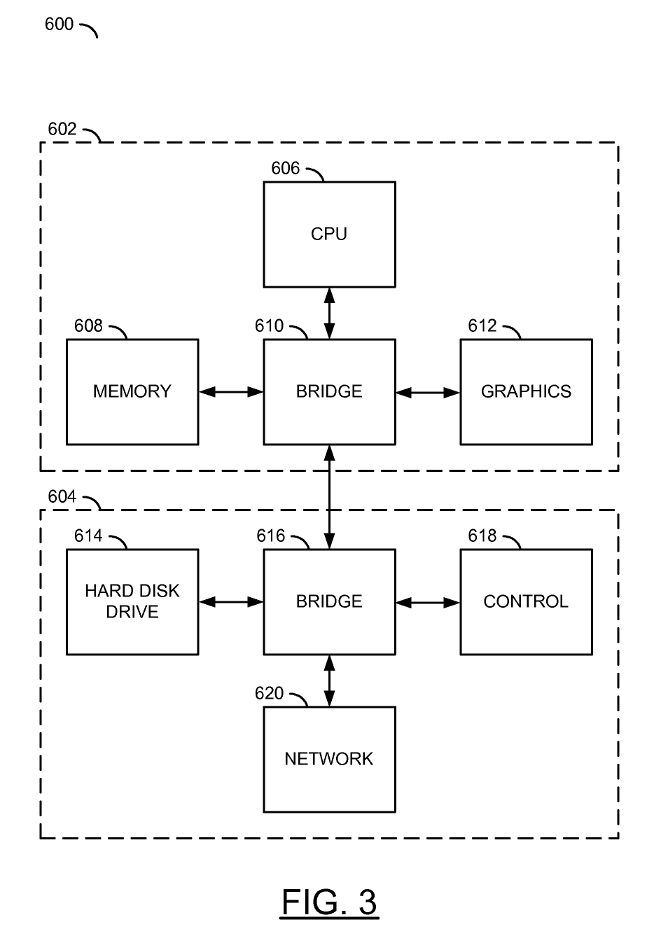

Referring to FIG. 3, a computer system 600 with a hard disk drive is shown. The system 600 may comprise a CPU subsystem circuit 602 and an I/O subsystem circuit 604. The circuit 602 generally comprises a CPU circuit 606, a memory circuit 608, a bridge circuit 610 and a graphics circuit 612. The circuit 604 generally comprises a hard disk drive 614, a bridge circuit 616, a control circuit 618 and a network circuit 620.

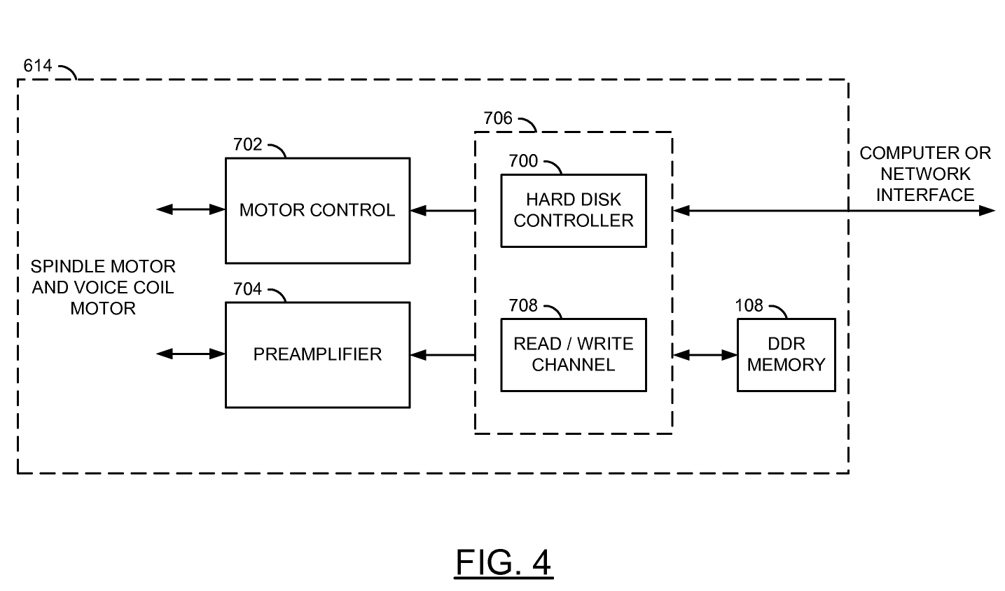

Referring to FIG. 4, a block diagram of a hard disk drive 614 is shown. The hard disk drive 614 generally comprises the DDR memory circuit 108, a motor control circuit 702, a preamplifier circuit 704 and a system-on-chip circuit 706. The circuit 706 may comprise a hard disk controller circuit 700 and a read/write channel circuit 708. The hard disk controller circuit 700 may transfer data between a drive and a host during read/write. The hard disk controller circuit 700 may also provide servo control. The motor control circuit 702 may drive a spindle motor and a voice coil motor. The preamplifier circuit 704 may amplify signals to the read/write channel circuit 708 and for head write data.

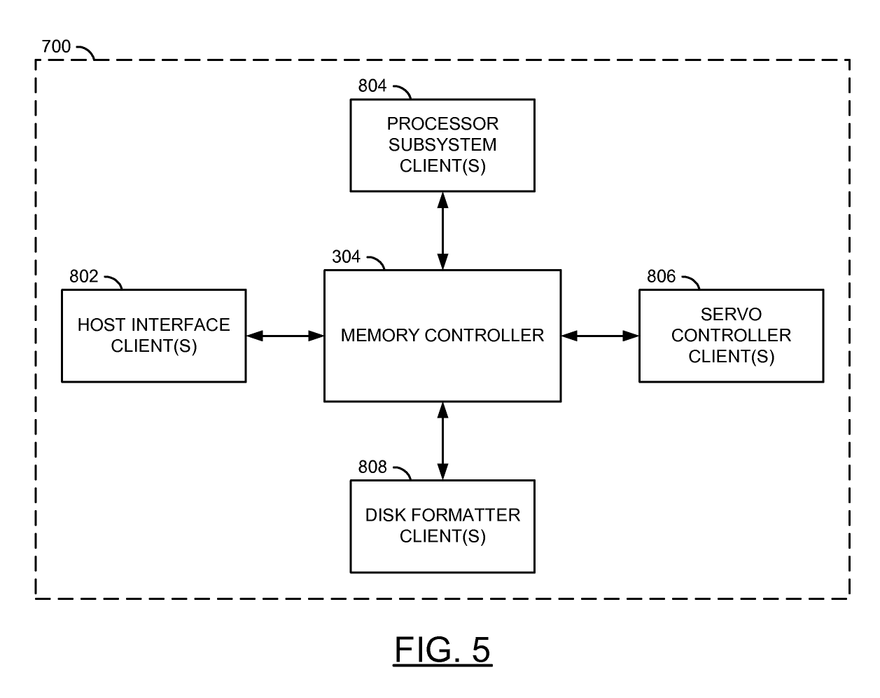

Referring to FIG. 5, a block diagram of a hard disk controller 700 is shown. The hard disk controller 700 generally comprises the memory controller circuit 304, a host interface client circuit 802, a processor subsystem client circuit 804, a servo controller client circuit 806 and a disk formatter client circuit 808. In one example, the circuit 804 may be a dual ARM processor subsystem. However, the particular type of processor implemented may be varied to meet the design criteria of a particular implementation. The protocol engine circuit 106 located in the memory controller 304 may manage data movement between a data bus and host logic from the host interface client circuit 802. The host interface client circuit 802 may process commands from the protocol engine 106. The host interface client circuit 802 may also transfer data to and/or from the memory controller circuit 304 and the protocol engine 106. The disk formatter client circuit 808 may move data between the memory controller circuit 304 and media. The disk formatter client circuit 808 may also implement error correcting code (ECC). The processor subsystem client circuit 804 may configure the registers in the memory controller 304 and block 306 for the purpose of performing initialization and training sequences to the memory controller 304, the circuit 306, the memory 110a and/or the memory 316b

As used herein, the term “simultaneously” is meant to describe events that share some common time period but the term is not meant to be limited to events that begin at the same point in time, end at the same point in time, or have the same duration.

As would be apparent to those skilled in the relevant art(s), the signals illustrated in FIGS. 1-5 represent logical data flows. The logical data flows are generally representative of physical data transferred between the respective blocks by, for example, address, data, and control signals and/or busses. The system represented by the circuit 100, and the various sub-components, may be implemented in hardware, software or a combination of hardware and software according to the teachings of the present disclosure, as would be apparent to those skilled in the relevant art(s).

The present invention may be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

While the invention has been particularly shown and described with reference to the preferred embodiments thereof, it will be understood by those skilled in the art that various changes in form and details may be made without departing from the scope of the invention.

1. An apparatus comprising:
a plurality of buffers each configured to generate a control signal in response to a respective one of a plurality of channel requests received from a respective one of a plurality of clients; and
a channel router circuit configured to connect one or more of said buffers to one of a plurality of memory resources, wherein said channel router circuit returns a data signal to a respective one of said buffers in an order requested by each of said clients.

2. The apparatus according to claim 1, wherein each of said memory resources comprises (i) an arbiter, (ii) a protocol engine, and (iii) a memory device.

3. The apparatus according to claim 1, wherein each of said memory resources comprises:
an arbiter circuit configured to receive each of a plurality of control signals;
a protocol engine circuit configured to receive a selected one of said control signals; and
a memory circuit configured to store and present said data signal in response to said selected control signal.

4. The apparatus according to claim 3, wherein each of said protocol engines presents and receives a respective one of said data signals from said channel router circuit.

5. The apparatus according to claim 3, wherein said memory circuits are implemented on an integrated circuit along with said plurality of buffers and said channel router circuit.

6. The apparatus according to claim 3, wherein said memory circuits are implemented on a separate integrated circuit from said plurality of buffers and said channel router circuit.

7. The apparatus according to claim 3, wherein said channel router circuit is configured to allow regioning of a physical layout.

8. The apparatus according to claim 3, wherein said memory circuits are interleaved by low address bits to increase memory bandwidth.

9. The apparatus according to claim 3, wherein each of said memory circuits is configured to share a common address space.

10. The apparatus according to claim 3, wherein one or more of said requestors operates at a first frequency that is different than a second frequency that one or more of said memory circuits operates.

11. The apparatus according to claim 1, wherein said channel router circuit allows each of said clients to simultaneously initiate access to one or more of said memory resources.

12. The apparatus according to claim 1, wherein said channel router allows independent arbitration of each of said memory resources.

13. The apparatus according to claim 1, wherein said channel router allows independent criteria to be used for arbitration of said memory resources.

14. The apparatus according to claim 1, wherein said apparatus allows parallel access by two or more of said clients of one or more of said memory resources.

15. The apparatus according to claim 1, wherein the number of said plurality of buffers may be scaled to accommodate a particular number of clients.

16. The apparatus according to claim 1, wherein the plurality of said buffers are implemented for each of said plurality of clients.

17. The apparatus according to claim 1, wherein said buffers each comprise first-in, first-out FIFO buffers.

18. The apparatus according to claim 1, wherein said memory resources comprise at least one of (i) a Dynamic Random Access Memory (DRAM), (ii) a Synchronous Random Access Memory (SRAM), (iii) a DDR memory, (iv) a RDRAM memory, (v) a flash memory, (vi) a non-volatile memory, (vii) a volatile memory and (viii) other type of available memory.

19. The apparatus according to claim 1, wherein said apparatus is implemented as an integrated circuit.

20. A method for partitioning a memory for access by a plurality of requestors comprising the steps of:
(A) generating a control signal in a buffer in response to a respective one of a plurality of channel requests received from a respective one of a plurality of clients; and
(B) connecting one or more of said buffers to one of a plurality of memory resources, wherein step (B) returns a data signal to a respective one of said buffers in an order requested by each of said clients.
